(19) United States
(12) Patent Application Publication
(10) Pub. No.: US 2006/0017876 A1
(43) Pub. Date: Jan. 26, 2006

(54) Displays and method for fabricating displays

(75) Inventor: Michael P.C. Watts, Austin, TX (US)

Correspondence Address: MOLECULAR IMPRINTS, INC.;KENNETH C. BROOKS, PO BOX 81536, AUSTIN, TX, 78708-1536, US

(73) Assignee: MOLECULAR IMPRINTS, INC., Austin, TX (US)

(21) Appl. No.: 10/897,734

(22) Filed: Jul. 23, 2004

(51) Int. Cl. G02F 1/1339

(52) U.S. Cl. 349/153; 349/190

(57) ABSTRACT

One embodiment of the present invention relates to a method for fabricating a display that includes: (a) fabricating a sealing wall having a first height about a periphery of first display structures that have been fabricated on a first substrate; (b) fabricating a containment wall having a second height about the periphery and outside the sealing wall, the second height being less than the first height; (c) dispensing a sealing material between the sealing wall and the containment wall; (d) contacting a second substrate having second display structures to the first substrate; and (e) setting the sealing material to bond the first and second substrates.

### TECHNICAL FIELD OF THE INVENTION

One or more embodiments of the present invention relate to displays and methods for fabricating such displays, which methods include imprint lithography techniques.

### BACKGROUND OF THE INVENTION

Recent developments in information communication have increased demand for various types of display devices. In response to this demand, various flat panel displays such as, for example and without limitation, liquid crystal displays or liquid crystal display devices (LCDs), plasma display panels (PDPs), electro luminescent displays (ELDs), and vacuum fluorescent displays (VFDs) have been developed. As used herein, LCDs include both direct viewing LCDs and projection type LCDs. LCDs have been used widely as mobile displays such as, for example and without limitation, displays for telephones and notebook computers because of, among other things, their small size, light weight, thin profile, and low power consumption. In addition to their use as mobile displays, LCDs have been developed as general displays as a replacement for Cathode Ray Tubes (CRTs) in computer monitors and televisions.

A typical LCD comprises: (a) an LCD panel that includes a liquid crystal layer for displaying a picture (typically the LCD panel is formed from first and second substrates, for example, glass substrates, that are bonded together—while being separated by a predetermined interval—with a liquid crystal interposed between the two substrates); (b) a light source; (c) electrodes; and (d) circuit components for applying driving voltages to the liquid crystal panel (for example, a driver circuit and a power supply circuit). Such a typical LCD provides a display by utilizing variations in polarization states of a light ray transmitted through the liquid crystal layer. The polarization state of the light ray is changed by orientation directions of liquid crystal molecules, which orientation directions, in turn, are changeable by applying a voltage to the liquid crystal layer. Portions of the driver circuit and power supply circuit may either form integral parts of the LCD panel or be mounted on the LCD panel.

FIG. 1 shows a cross section of a portion of a liquid crystal panel that has been fabricated in accordance with the prior art. As shown in FIG. 1, LCD 1000 includes substrate 701, substrate 702, liquid crystal layer 703 formed between substrates 701 and 702, and spacer 720 that maintains a uniform interval between substrates 701 and 702. Substrate 701 is a substrate that carries thin film transistor (TFT) switching devices that selectively turn data signals on/off in accordance with gate voltages. To that end, substrate 701 also carries a plurality of gate lines arranged in a first direction at fixed intervals, a plurality of data lines arranged in a second direction perpendicular to the gate lines at fixed intervals, and a plurality of pixel electrodes in respective pixel regions defined by the gate lines and the data lines arranged in a matrix. As is well known, a TFT is switchable in response to signals on the gate lines for transmission of a signal on the data line to the pixel electrodes. As shown in FIG. 1, a gate line includes gate electrode 711 for a TFT and gate insulating layer 712 (for example, gate insulating layer 712 is a silicon nitride (SiNₓ) layer) disposed over substrate 701 and gate electrode 711. As further shown in FIG. 1, semiconductor layer 713 is disposed on gate insulating layer 712 and over gate electrode 711, and data line 714 crosses the gate line. As further shown in FIG. 1, source electrode 714a and drain electrode 714b are disposed on semiconductor layer 713, and passivation layer 715 is formed over substrate 701 (for example, passivation layer 715 is a silicon nitride (SiNₓ) layer), including over source electrode 714a and drain electrode 714b. Pixel electrode 708 (for example, pixel electrode 708 is formed from indium tin oxide (ITO)) that connects to drain electrode 714b is formed on passivation layer 715. As further shown in FIG. 1, alignment layer 704a extends over the entire surface of substrate 701, including pixel electrode 708.

As further shown in FIG. 1, substrate 702 supports a color filter layer for expressing colors. As is well known, substrate 702 has a black matrix layer for shielding light from areas excluding the pixel regions, a color filter layer (R, G, B), and a common electrode for implementing a picture. In particular, the following are disposed on substrate 702: black matrix 716 that prevents light leakage, color filter layer 717 (RGB) which is disposed between neighboring areas of black matrix 716, and passivation layer 718 which is disposed over the entire surface of substrate 702. Passivation layer 718 protects color filter layer 717. As further shown in FIG. 1, common electrode 719 (for example, common electrode 719 is formed from ITO) is formed on passivation layer 718. As further shown in FIG. 1, alignment layer 704b extends over the entire surface of substrate 702.

As is well known, substrates 701 and 702 have a gap between them which is maintained by a number of spacers, for example, spacer 720 shown in FIG. 1, that maintain a uniform distance between substrates 701 and 702 when they are placed together and are bonded by a sealant. The edges of substrates 701 and 702 are sealed with an epoxy to form a seal, and the seal typically has a liquid crystal injection inlet (for example, a gap in one corner) through which the liquid crystal is injected (in a vacuum) after the two substrates are bonded and sealed. Afterwards, the space between the bonded two substrates of each LCD panel is evacuated, and the liquid crystal injection inlet is dipped in a liquid crystal bath so that the liquid crystal is injected into the space by capillary action. Once the liquid crystal is injected into the space between the two substrates, the liquid crystal injection inlet is sealed.

Another method for fabricating an LCD entails using a liquid crystal dropping method rather than the liquid crystal injection method described above. In accordance with such an alternative method, a sealant (for example, a UV sealant) is coated on a first substrate having a TFT array formed thereon to a thickness of approximately 30 μm, and liquid crystal is dropped on the substrate interior of the sealant, which interior includes the TFT array area (as such, a liquid crystal injection inlet is not provided in the sealant). The substrate is typically mounted on a table in a vacuum chamber, and a second substrate, having a color filter array formed thereon, is held in the vacuum chamber over the first substrate. The second substrate is moved downward in a vertical direction, the substrates are aligned, and they are moved toward each other until the second substrate comes into contact with, and bonds with, the first substrate through the sealant (as is well known, further alignment steps may be interposed). Next, the sealant is hardened (for example, UV rays are directed to the sealant or the temperature is raised to set it). Next, the bonded substrates may be cut into individual panels, and each panel may be polished and inspected.

In a variant of the above-described alternative, liquid crystal is dropped or applied on the first substrate, and a sealant is coated on the second glass substrate. Next, the two substrates are brought together for bonding and spreading the liquid crystal between the substrates uniformly. Next, the sealant is set. Next, the bonded substrates may be cut into individual panels, and each panel may be polished and inspected. Although it has been described that the liquid crystal is dispensed on a substrate having a TFT array, and the sealant is coated on a substrate having a color filter array, the sealant may be applied to both substrates, or the liquid crystal and the sealant may be applied on either of the substrates.

One problem with such prior art methods relates to the sealing process because the sealant is unconstrained and provides process variability which results in quality issues and poor manufacturing yields.

An LCD has numerous functional requirements, including light transmission characteristics, operational response time, viewing angle, and contrast. Many of those requirements are impacted by alignment characteristics of liquid crystal molecules in the LCD. Indeed, uniformly aligned liquid crystal molecules are important to the electro-optical characteristics of an LCD, and the alignment characteristics of the LCD are provided by an alignment layer. As is well known, alignment films are typically formed in the following manner. First, an organic polymer film, for example, a polyimide film, is deposited over a substrate on which electrodes and circuit components are provided. Next, the surface of the organic polymer film is mechanically rubbed with a cloth in a predetermined direction, thereby obtaining an alignment film having the function of aligning the liquid crystal molecules in the predetermined direction. While the rubbing technique is a simple process, it has problems. For example, various process variables related to rubbing are difficult to accurately control. Further, dust adsorption, unwanted scratches generated by the rubbing, and damage to TFTs caused by static electricity can also result from the rubbing. Still further, in the rubbing treatment, pressure cannot always be applied uniformly. As a result, the liquid crystal molecules may have their pretilt angles disturbed so as to form rubbing stripes in small domains of the liquid crystal layer. Such problems reduce manufacturing yields and the performance of LCDs. Because of the forgoing problems, significant effort has been expended in developing alternative alignment techniques.

One type of such alternative techniques involves photo-alignment methods which include photo-decomposition, photo-polymerization, and photo-isomerization. In accordance with such methods, optical anisotropy is brought about in a polymer layer by inducing a photo-reaction after most of the molecules facing a polarizing direction in disorderly-aligned polymer molecules have absorbed light. To form a photo-alignment layer using a photo-alignment material, the photo-alignment material is uniformly coated on a substrate. The photo-alignment layer material is then thermally treated and dried in an oven. Subsequently, a structure that assists anisotropy of the liquid crystals is attained by irradiating polarized UV rays onto the exposed surface of the photo-alignment layer.

Prior art photo-alignment materials, and LCDs using the same, have problems. For example, the alignment tends to be easily broken by thermal, physical, electrical, and photo shocks. Further, the alignment tends to be hard to restore.

Another alternative alignment technique is disclosed in an article by S. Park et al. entitled “Aligning Liquid Crystals Using Replicated Nanopatterns,” PSI Scientific Report 2002/Volume VII, p. 85, March 2003. The disclosed alignment technique entails producing alignment layers for liquid crystal cells using imprint lithography. As disclosed in the article, PMMA was coated on a surface, and relief patterns were imprinted in the PMMA using imprint lithography. Then, the relief patterns were opened to the substrate by etching, and a hydrophobic silane (for example, (tridecafluro-1,1,2,2-tetrahydrooctyl)-trichlorosilane (TFS), was deposited from the gas phase over the opened relief patterns. Finally, a lift-off process of the remaining PMMA left alignment patterns of TFS on the substrate. One problem to be solved with this method is how to integrate the generation of such an alignment method with fabrication of an LCD panel as described above.

In light of the above, there is a need for displays and methods to improve fabrication of such displays that overcome one or more of the above-identified problems.

### SUMMARY OF THE INVENTION

One or more embodiments of the present invention satisfy one or more of the above-identified needs in the art. In particular, one embodiment of the present invention is a method for fabricating a display that comprises: (a) fabricating a sealing wall having a first height about a periphery of first display structures that have been fabricated on a first substrate; (b) fabricating a containment wall having a second height about the periphery and outside the sealing wall, the second height being less than the first height; (c) dispensing a sealing material between the sealing wall and the containment wall; (d) contacting a second substrate having second display structures to the first substrate; and (e) setting the sealing material to bond the first and second substrates.

### BRIEF DESCRIPTION OF THE DRAWING

FIG. 1 shows a cross section of a portion of a liquid crystal device (LCD) that has been fabricated in accordance with the prior art;

FIG. 2 is a cross-sectional view of a portion of an LCD during fabrication in accordance with one or more embodiments of the present invention;

FIG. 3 shows a top view of the portion of the LCD that shows a sealing wall and a containment wall that have been fabricated in accordance with one or more embodiments of the present invention;

FIG. 4 is a cross-sectional view of a portion of an LCD that is fabricated in accordance with one or more embodiments of the present invention;

FIG. 5 is a cross-sectional view of a portion of an LCD that is fabricated in accordance with one or more alternative embodiments of the present invention;

FIG. 6 is a perspective view of a lithographic system useful in carrying out one or more embodiments of the present invention; and

FIG. 7 is a simplified cross-sectional view of an imprint template spaced-apart from the imprinting layer shown in FIG. 6.

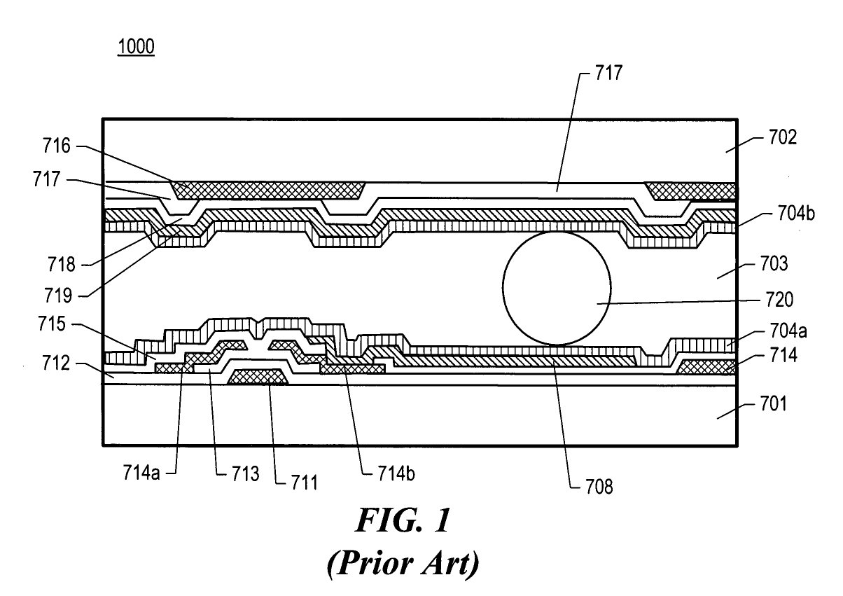

### DETAILED DESCRIPTION OF THE INVENTION

One or more embodiments of the present invention relate to methods for fabricating displays such as, for example and without limitation, liquid crystal display devices (LCDs) using imprint lithography.

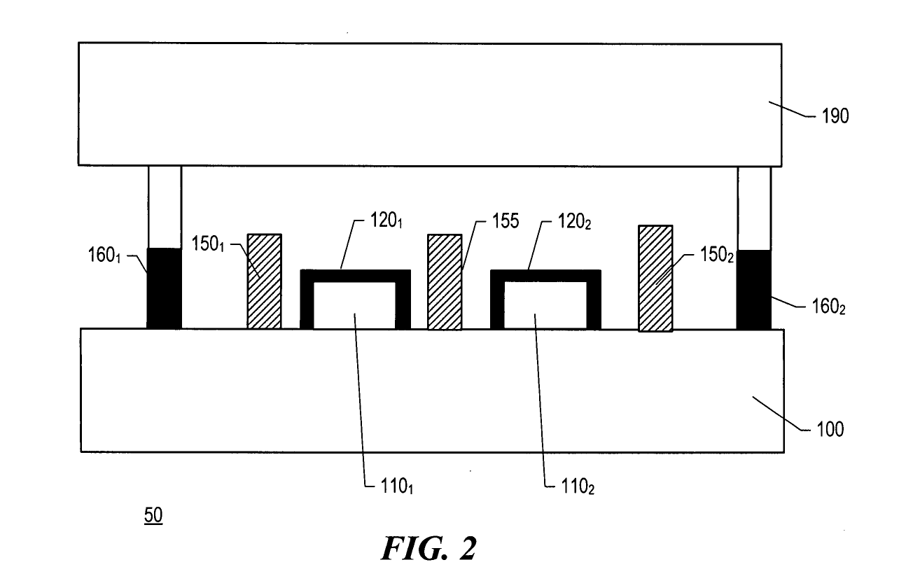

FIG. 2 is a cross-sectional view of a portion of liquid crystal display device 50 (LCD 50) during fabrication in accordance with one or more embodiments of the present invention. As shown in FIG. 2, a first part of LCD 50 is fabricated in accordance with any one of a number of methods that are well known to those of ordinary skill in the art to provide substrate 100 (for example and without limitation, a glass substrate), active areas 110₁ and 110₂ disposed on substrate 100, and alignment layers 120₁ and 120₂ (for example and without limitation, polyimide, polyamide, polyamic acid, and SiO₂) formed over, among other places, active areas 110₁ and 110₂. It should be noted that active areas 110₁ and 110₂ may include switching transistors or color filters (depending on which of two portions of the LCD is being used to fabricate sealing wall 150 and containment wall 160 (described in detail below). As depicted in FIG. 2, active areas 110₁ and 110₂ each represent multiplicities of pixels. For example and without limitation, as is well known to those of ordinary skill in the art, and as was described in the Background of the Invention, forming active areas 110₁ and 110₂ may include steps such as: forming gate lines and crossing data lines on substrate 100; forming thin film transistors at crossings between the gate and data lines; and forming pixel electrodes connected to the thin film transistors. Alternatively, for example and without limitation, and as was described in the Background of the Invention, forming active areas 110₁ and 110₂ may include steps such as: forming a light leakage protection layer and a color filter layer on substrate 100; forming a passivation layer thereover; and forming electrodes on the passivation layer.

Next, in accordance with one or more embodiments of the present invention, sealing wall 150 (portions 150₁ and 150₂ are shown in the cross-sectional view of FIG. 2) is formed on substrate 100 around a periphery of LCD 50. Optional separation posts (illustrated by separation post 155 in FIG. 2) may be formed at predetermined intervals about the surface of substrate 100, which separation posts may serve as separators which maintain a predetermined separation interval between LCD substrates. Next, in accordance with such one or more embodiments of the present invention, containment wall 160 (portions 160₁ and 160₂ are shown in the cross-sectional view of FIG. 2) is formed on substrate 100 around a periphery of LCD 50 and outside of sealing wall 150. As shown in FIG. 2, and in accordance with one or more embodiments of the present invention, the height of containment wall 160 is less than the height of sealing wall 150. Advantageously, as will be explained below, it is believed that sealing wall 150 and containment wall 160 provide a dual wall wherein: (a) sealing wall 150 contains sealing material from entering an inner portion of the LCD; and (b) containment wall 160 provides flow relief for excess sealing material.

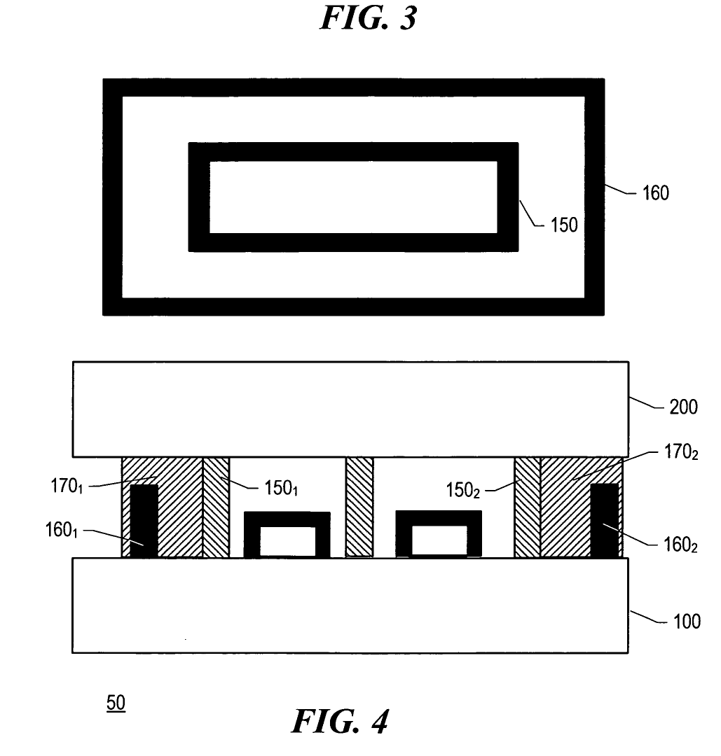

FIG. 3 shows a top view of LCD portion 50 that shows sealing wall 150 and containment wall 160 (without other structure to make it easier to understand the one or more embodiments of the present invention) that have been fabricated in accordance with one or more embodiments of the present invention. As shown in FIG. 3, sealing wall 150 surrounds a periphery of LCD 50, and containment wall 160 surrounds sealing wall 150 and is outside sealing wall 150.

In accordance with one or more embodiments of the present invention, wall sealing wall 150 may be an oxide (for example, SiOₓ), a nitride (for example, SiNₓ), an oxynitride (SiOₓN_{y}), or any other suitable material. Sealing wall 150, and optional separation posts 155, may be formed utilizing any one of a number of fabrication techniques that are well known to those of ordinary skill in the art such as masking techniques and etching techniques to provide openings (through structure and layers on substrate 100) to substrate 100. Then, in accordance with any one of a number of methods that are well known to those of ordinary skill in the art, sealing wall 150, and optional separation posts 155 are formed to provide the structural configuration illustrated in FIGS. 2 and 3. Such methods would include chemical vapor deposition techniques using any one of a number of well known precursors. Next, any residual masking material and superfluous material of which sealing wall 150 is formed may be removed using any one of a number of methods that are well known to those of ordinary skill in the art, including, for example and without limitation, lift-off processes. Next, containment wall 160 is formed in a manner that will be described in detail below.

FIG. 4 is a cross-sectional view of LCD 50 that is fabricated in accordance with one or more embodiments of the present invention. As shown in FIG. 4, to form an LCD, the structure having sealing wall 150 and containment wall 160 formed as shown in FIG. 2 has sealing material 170 (portions 170₁ and 170₂ are shown in the cross-sectional view of FIG. 4) disposed between sealing wall 150 and containment wall 160. In accordance with such one or more embodiments of the present invention, the sealing material may be any one of a number of epoxy materials that are well known to those of ordinary skill in the art. Then, in accordance with any one of a number of methods that are well known to those of ordinary skill in the art: (a) substrate 200 which carries another side of the LCD is placed on top of the structure formed on substrate 100; (b) the two parts are aligned in accordance with any one of a number of methods that are well known to those of ordinary skill in the art; and (c) the two parts are brought together so that the spacing between the two parts is determined by the height of containment wall 150, and optional separation posts 155 (if separation posts 155 are not utilized, then any one of a number of other spacer mechanisms that are well to those of ordinary skill in the art may be utilized). In accordance with one or more such embodiments, containment wall 150 may be from about 1 μm to about 2 μm high and from about 10 μm to about 20 μm wide, and containment wall 160 may a few hundred nanometers high and a few hundred nanometers wide. In addition, in accordance with one or more embodiments of the invention, sealing material 170 may leak over containment wall 160 (due, for example, to overfilling of sealing material 170) but it will be prevented from flowing into the interior of the LCD by sealing wall 150. Lastly, sealing material 170 is set or cured in accordance with any one of a number of methods that are well known to those of ordinary skill in the art to seal the LCD. Further steps of fabrication relating to injection of liquid crystal material may be carried out in accordance with any one of a number of methods that are well known to those of ordinary skill in the art. For example, a predetermined liquid crystal material may be injected into a gap between the substrates within a vacuum (which gap was created when sealing wall 160 and containment wall 160 were fabricated), and then the gaps are sealed. In addition, in an alternative embodiment, liquid crystal material may be placed on the structure formed on substrate 100 before or after sealing material 150 is applied, but before the LCD is sealed.

In accordance with one or more embodiments of the present invention, containment wall 160 may be formed by the same technique and material used to form sealing wall 150. Alternatively, containment wall 160 may be formed utilizing imprint lithography techniques wherein containment wall 160 is formed from an imprinting material, for example and without limitation, an acrylate or any low viscosity, UV curable liquid, by depositing the imprinting material for containment wall 160 as a series of drops along a path on substrate 100 upon which containment wall 160 is to be formed. Then, as shown in FIG. 2, imprint template 190 is directed to approach substrate 100 at a predetermined distance to contact the imprinting material to provide containment wall 160 having a predetermined height. Next, the imprinting material is cured utilizing any one of a number of methods that are well known to those of ordinary skill in the art such as, for example and without limitation, UV curing. Appropriate heights for containment wall 160, and appropriate distances from sealing wall 150, can be determined routinely by one of ordinary skill in the art without undue experimentation to provide an appropriate “leaky seal” for use in fabricating LCDs.

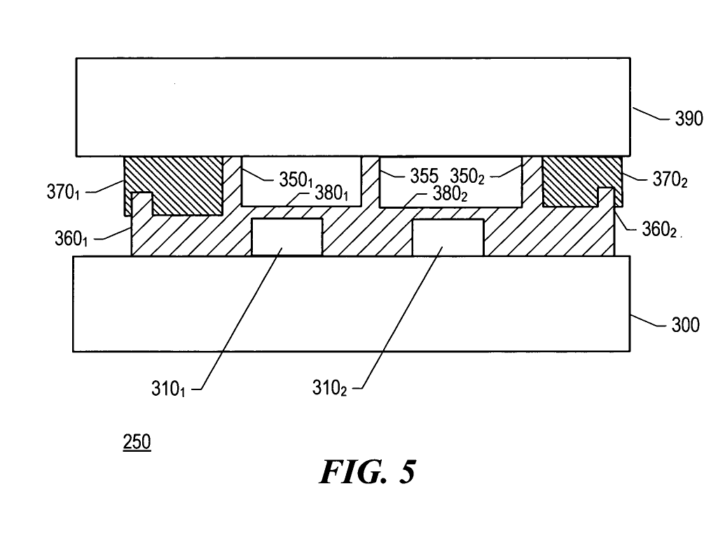

FIG. 5 is a cross-sectional view of a portion of an LCD 250 that is fabricated in accordance with one or more alternative embodiments of the present invention. As shown in FIG. 5, as was described above, a first part of LCD 250 is fabricated in accordance with any one of a number of methods that are well known to those of ordinary skill in the art to provide substrate 300 (for example and without limitation, a glass substrate), active areas 310₁ and 310₂ disposed on substrate 300. It should be noted that active areas 310₁ and 310₂ may include switching transistors or color filters (depending on which of two portions of the LCD is being used to fabricate sealing wall 350 and containment wall 360 (described in detail below). As depicted in FIG. 5, active areas 310₁ and 310₂ represent multiplicities of pixels and may be fabricated in the manner described above in conjunction with FIG. 2.

Next, in accordance with one or more embodiments of the present invention, an imprinting material from which alignment layer 380 (portions 380₁ and 380₂ are shown in the cross-sectional view of FIG. 5), sealing wall 350 (portions 350₁ and 350₂ are shown in the cross-sectional view of FIG. 5), optional separation posts (illustrated by separation post 355 in FIG. 5), and containment wall 360 (portions 360₁ and 360₂ are shown in the cross-sectional view of FIG. 5) are to be formed is deposited over the structure formed on substrate 300. The imprinting material is useful in forming structures utilizing imprint lithography and may be selected from any one of a number of such imprinting materials that are well known to those of ordinary skill in the art such as, for example and without limitation, polyimide. Next, structures including containment wall 360, sealing wall 350, separation posts 355, and alignment layer 380 are: (a) formed utilizing an imprint template in accordance with well known methods of imprint lithography; and (b) solidified utilizing well known techniques of imprint lithography to cure the imprinting material. Next, substrate 390 (along with structures carried thereby) is affixed to substrate 300 (along with structures carried thereby) in the same manner that was described above in conjunction with FIG. 4. Many methods are well known for fabricating a suitable imprint template to provide the structures described above. For example and without limitation, the imprint template may be fabricated from quartz, and an appropriate relief pattern may be etch therein in accordance with any one of a number of methods that are well known to those of ordinary skill in the art. In particular, the dimensions of the structures are so much larger than demanding dimensions typically associated with state-of-the art semiconductor fabrication, that a whole host of techniques and imprinting materials that might not be suitable for sophisticated semiconductor fabrication would be suitable for fabricating LCDs. For example, the most demanding portion of the imprint template would be that responsible for providing alignment patterns having widths on the order of about 80 nm to about 200 nm. In addition, one or more further embodiments of the present invention include the use of a multiplicity of imprint templates, for example one imprint template for fabricating the sealing and containment walls, and another imprint template for fabricating the alignment layer. Lastly, an alignment layer may be fabricated on substrate 390 using imprint lithographic methods.

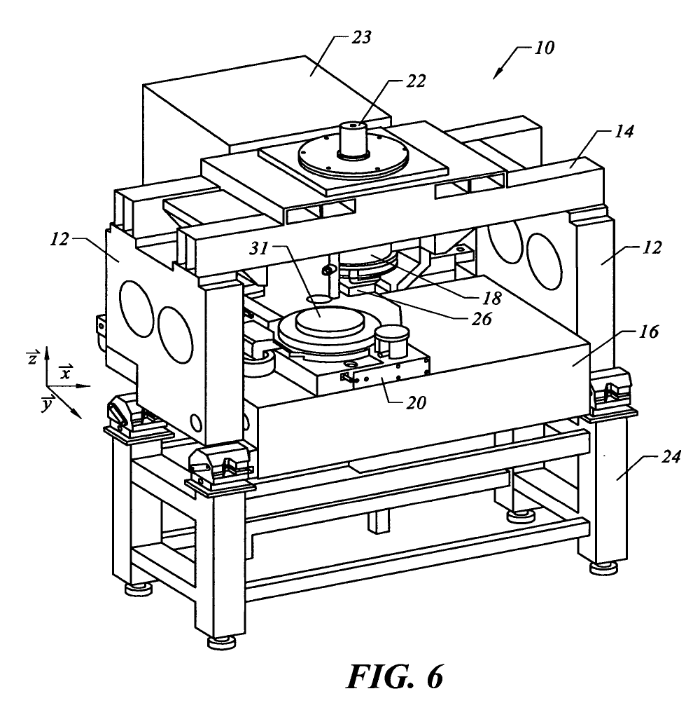

FIG. 6 shows lithographic system 10 that may be used to carry out the imprint lithography steps described above in accordance with one or more embodiments of the present invention. As shown in FIG. 6, system 10 includes a pair of spaced-apart bridge supports 12 having bridge 14 and stage support 16 extending therebetween. As further shown in FIG. 6, bridge 14 and stage support 16 are spaced-apart. Imprint head 18 is coupled to bridge 14, and extends from bridge 14 toward stage support 16. Motion stage 20 is disposed upon stage support 16 to face imprint head 18, and motion stage 20 is configured to move with respect to stage support 16 along X and Y axes. An exemplary motion stage device is disclosed in U.S. patent application Ser. No. 10/194,414, filed Jul. 11, 2002, entitled “Step and Repeat Imprint Lithography Systems,” assigned to the assignee of the present invention, and which is incorporated by reference herein in its entirety. Radiation source 22 is coupled to system 10 to impinge actinic radiation upon motion stage 20. As further shown in FIG. 6, radiation source 22 is coupled to bridge 14, and includes power generator 23 connected to radiation source 22. An exemplary lithographic system is available under the trade name IMPRIO 100™ from Molecular Imprints, Inc. having a place of business at 1807-C Braker Lane, Suite 100, Austin, Tex. 78758. The system description for the IMPRIO 100™ is available at www.molecularimprints.com and is incorporated herein by reference. As is well known, imprint patterns are fabricated using lithographic system 10 by stepping across the substrate in accordance with imprint lithography methods that are well known to those of ordinary skill in the art.

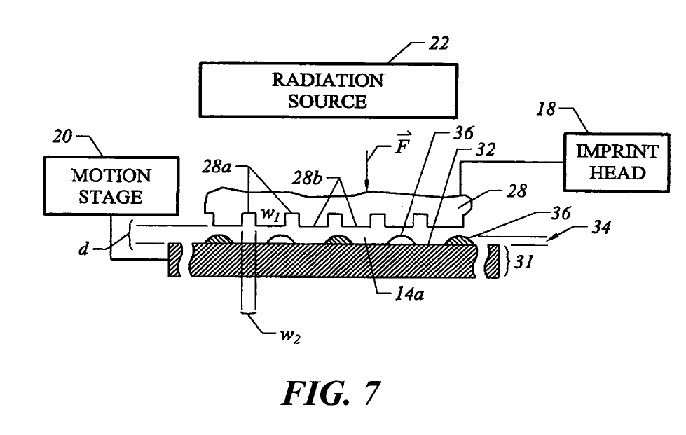

FIG. 7 is a simplified cross-sectional view of an imprint template spaced-apart from the imprinting layer shown in FIG. 6. Referring to FIG. 7, connected to imprint head 18 is imprint template 28 that includes a plurality of features defined by a plurality of spaced-apart recessions 28a and protrusions 28b. The plurality of features defines a pattern that is to be transferred into substrate 31 positioned on motion stage 20. As described above, substrate 31 includes the portion of the LCD: (a) onto which containment wall 160 is to be molded (as was described above in conjunction with FIG. 2); or (b) onto which containment wall 360, sealing wall 350, optional separation posts 355, and alignment layer 380 are to be molded (as was described above in conjunction with FIG. 5). To that end, imprint head 18 is adapted to move along the Z axis and vary a distance “d” between imprint template 28 and substrate 31. In this manner, the desired features on imprint template 28 may be imprinted into a conformable region of substrate 31. Radiation source 22 is located so that imprint template 28 is positioned between radiation source 22 and substrate 31. As a result, imprint template 28 is fabricated from material that allows it to be substantially transparent to the radiation produced by radiation source 22.

Referring to FIG. 7, a conformable region, such as imprinting layer 34, is disposed on a portion of surface 32 that presents a predetermined profile. It should be understood that the conformable region may be formed using any known technique to produce conformable material on surface 32 such as, for example and without limitation, a hot embossing process disclosed in U.S. Pat. No. 5,772,905 to Chou, or a laser assisted direct imprinting (LADI) process of the type described by Chou et al. in Ultrafast and Direct Imprint of Nanostructures in Silicon, Nature, Col. 417, pp. 835-837, June 2002. In accordance with one or more embodiments of the present invention, the conformable region is deposited as a plurality of spaced-apart discrete droplets 36 of imprinting material on substrate 31. An exemplary system for depositing droplets 36 is disclosed in U.S. patent application Ser. No. 10/191,749, filed Jul. 9, 2002, entitled “System and Method for Dispensing Liquids,” and which is assigned to the assignee of the present invention, and which is incorporated by reference in its entirety herein. Imprinting layer 34 is formed from an imprinting material that may be selectively polymerized and cross-linked to record the original pattern therein, defining a recorded pattern. An exemplary composition for the imprinting material is disclosed in U.S. patent application Ser. No. 10/463,396, filed Jun. 16, 2003 and entitled “Method to Reduce Adhesion between a Conformable Region and a Pattern of a Mold,” which is incorporated by reference in its entirety herein.

Referring to FIG. 7, a pattern recorded in imprinting layer 34 is produced, in part, by mechanical contact with imprint template 28. To that end, imprint head 18 reduces the distance “d” to allow imprinting layer 34 to come into mechanical contact with imprint template 28, spreading droplets 36 so as to form imprinting layer 34 with a contiguous formation of imprinting material over a predetermined portion of surface 32. As is well known, distance “d” may be reduced to allow portions of imprinting layer 34 to ingress into and fill recessions 28a in imprint template 28.

To facilitate filling of recessions 28a, the imprinting material is provided with the requisite properties to fill recessions 28a while covering the predetermined portion of surface 32 with a contiguous formation of the imprinting material.

Referring to FIG. 7, after a desired distance “d” has been reached, radiation source 22 produces actinic radiation that polymerizes and cross-links the imprinting material, forming polymer material in which a substantial portion thereof is cross-linked. As a result, the imprinting material transforms to a material that is a solid. Specifically, the solidified material has a shape conforming to a shape of the surface of imprint template 28. Then, imprint head 18 is moved so that imprint template 28 and imprinting layer 34 are spaced-apart.

Exemplary radiation source 22 may produce ultraviolet radiation; however, any known radiation source may be employed. The selection of radiation employed to initiate the polymerization of the imprinting material in imprinting layer 34 is known to one skilled in the art and typically depends on the specific application which is desired. As one can readily appreciate, the plurality of features on imprint template 28, for example, recessions 28a and protrusions 28b, may correspond to virtually any feature required to create a containment wall, sealing wall, separation posts, and/or an alignment layer.

As is well known, imprint template 28 may be formed from various conventional materials, such as, for example and without limitation, fused-silica, quartz, silicon, organic polymers, siloxane polymers, borosilicate glass, fluorocarbon polymers, metal, hardened sapphire and the like.

As mentioned above, the imprinting material is deposited on substrate 31 as a plurality of discrete and spaced-apart droplets 36. The combined volume of droplets 36 is such that the imprinting material is distributed appropriately over an area of surface 32 where imprinting layer 34 is to be formed. As a result, imprinting layer 34 is spread and patterned concurrently, with the pattern being subsequently set into imprinting layer 34 by exposure to radiation, such as ultraviolet radiation. As a result of the deposition process, it is desired that the imprinting material have certain characteristics to facilitate rapid and even spreading of material 36a in droplets 36 over surface 32 so that all thicknesses are substantially uniform. Desirable characteristics include having a low viscosity, for example and without limitation, in a range of about 0.5 to about 5 centepoise (csp), as well as the ability to wet surface of substrate 31 and imprint template 28 and to avoid subsequent pit or hole formation after polymerization.

The constituent components that form the imprinting material to provide the aforementioned characteristics may differ. This results from substrate 31 being formed from a number of different materials. As a result, the chemical composition of surface 32 varies dependent upon the material from which substrate 31 is formed. For example, substrate 31 may be formed from silicon, plastics, glass, composites thereof, and so forth.

As is well known, to ensure proper release from an imprint template, a minimum surface energy is desired, for example and without limitation, by proper alignment of hydrophobic groups in the imprinting material at its interface with a surface of the imprint template. In accordance with one particular method of imprinting, the surface of the imprint template is pre-treated utilizing a surfactant solution consisting of 0.1% FSO-100 in isopropyl alcohol (“IPA”), and the imprinting material includes a small amount of FSO-100 (FSO-100 is a surfactant that is available under the designation ZONYL® FSO-100 from DUPONT™ (FSO-100 has a general structure of R₁R₂ where R₁=F(CF₂CF₂)_{Y}, with Y being in a range of 1 to 7, inclusive and R₂=CH₂CH₂O(CH₂CH₂O)_{X}H, where X is in a range of 0 to 15, inclusive). FSO-100 is a fluorinated surfactant having a molecular weight of about 600, and it aligns efficiently at the surface of the imprint template with hydrophobic —CF₃ groups projecting towards the surface of the imprint template. Such alignment is promoted by pre-treating the surface (prior to pre-treatment utilizing a surfactant solution consisting of 0.1% FSO-100 in IPA) to create silanol bonds on the surface.

Alternatively, one may use a different fluorinated surfactant from FSO-100, and in particular, a fluorinated surfactant that is available under the designation 3M Novec™ Fluorosurfactant FC-4432 (hereafter referred to as FC-4432) from 3M Company St. Paul, Minn. FC-4432 is a non-ionic polymeric fluorochemical surfactant belonging to a class of coating additives which provide low surface tensions in organic coating systems. The composition of FC-4432 is 87% polymeric fluorochemical actives, 7% non-fluorochemical actives, 5% 1-methyl-2-pyrudiinone, and <1% toluene. FC-4432 is a wetting, leveling and flow control agent for radiation curable polymer coating systems, and continues to be active throughout the curing process. FC-4432 is the first in a new line of fluorochemical surfactants from the 3M Company based on perfluorosulfate (PFBS), where PFBS refers collectively to perfluorobutane sulfonyl compounds including perfluorobutance sulfonates. In addition, such PFBS-based surfactants with only four perfluorinated carbon atoms offer improved environmental properties. The molecular weight of FC-4432 is about 4000, and because of its higher molecular weight than that of FSO-100, the fluorinated groups of FC-4432 align differently at the surface of an imprint template than those in FSO-100. In particular, besides —CF₃ groups of FSO-100, FC-4432 has a higher percentage of —CF₂ groups when compared to FSO-100. Because a —CF₂ group provides a higher surface energy than a —CF₃ group, the presence of a higher percentage of —CF₂ groups in FC-4432 provides a material having better wetting than FS-100. However, despite its higher surface energy, a —CF2— group is hydrophobic enough so that its use produces a material having a good release property. In addition, it is believed that the higher molecular weight of FC-4432 (when compared to that of FSO-100) causes FC-4432 to act like a loosely packed coil structure that results in more porous molecular packing of surfactant molecules at the surface of the imprint template. It is further believed that this coil structure helps enhance wetting over that provided by FSO-100 in addition to that provided by the presence of a higher percentage of —CF₂ groups in FC-4432 when compared to FSO-100.

An exemplary composition for the imprinting material that utilizes the surfactant FC-4432 is produced by mixing (with exemplary proportions being given in weight): (i) acryloxymethylpentamethyldisiloxane (for example and without limitation, about 37 gm) which is available under the designation XG-1064 from Gelest, Inc. of Morrisville, Pa., (ii) isobornyl acrylate (“IBOA”) (for example and without limitation, about 42 gm) which is available under the designation SR 506 from Aldrich Chemical Company of Milwaukee, Wis., (iii) ethylene glycol diacrylate (for example and without limitation, about 18 gm) which is available under the designation EGDA from Aldrich Chemical Company of Milwaukee, Wis., (iv) a UV photoinitiator, for example and without limitation, 2-hydrozy-2-methyl-1-phenyl-propan-1-one (for example and without limitation, about 3 gm) which is available under the designation Darocur 1173 from CIBA® of Tarrytown, N.Y.), and (iv) FC-4432 (for example and without limitation, about 0.5 gm). The above-identified composition may also include stabilizers that are well known in the chemical art to increase the operational life of the composition. In a typical such embodiment, the surfactant comprises less than 1% of the imprinting material. However, the percentage of the surfactant may be greater than 1%.

Another manner by which to improve the release properties of imprint template 28 includes conditioning the pattern of imprint template 28 by exposing the same to a conditioning mixture including an additive that will remain on imprint template 28 to reduce the surface energy of the imprint template surface. An exemplary additive is a surfactant.

The following describes a method for imprint lithography that utilizes one or more embodiments of the above-described imprinting material. As a first step, the surface of a quartz imprint template is pre-treated to create hydrophilic bonds at the surface, for example and without limitation silanol (Si—OH) bonds. In accordance with one or more embodiments of the present invention, the surface of the imprint template is dipped in a 2.5:1 solution of H₂SO₄ and H₂O₂ to hydrolyze the surface, i.e., to create silanol bonds at the surface. As a next step, the surface is further pre-treated by spraying the surface of the imprint template with a diluted FC-4432 solution (for example and without limitation, 0.1% FC-4432 in IPA). Exposure of the surface of the imprint template may be achieved by virtually any method known in the art, including dipping the surface into a volume of pre-treatment solution, wiping the surface with a cloth saturated with pre-treatment solution, and spraying a stream of pre-treatment solution onto the surface. The IPA in the pre-treatment solution may be allowed to evaporate before using the imprint template 28. In this manner, the IPA facilitates removing undesired contaminants from the surface while leaving the surfactant. Because the surfactant includes a hydrophobic, fluorine-rich end, and a hydrophilic end, the silanol bonds promote alignment of the surfactant so that the hydrophilic end “attaches” to the —OH end of the silanol bonds, and the hydrophobic, fluorine-rich end points away from the surface. In a next step, a gap between the imprint template and the substrate may be purged of air (mainly O₂ and N₂) using, for example and without limitation, an ˜5 psi Helium purge. In a next step, the imprinting material containing the FC-4432 surfactant is applied to the substrate, for example and without limitation, by placing a pattern of substantially equidistant droplets of imprinting material on the substrate, by spin-coating, or by any other method known to those of ordinary skill in the art. Next, the familiar steps of imprint lithography are carried out, i.e., exposure to actinic radiation to polymerize the imprinting material; and separation of the imprint template and the substrate.

The embodiments of the present invention described above are exemplary. Many changes and modifications may be made to the disclosure recited above, while remaining within the scope of the invention. The scope of the invention should, therefore, be determined not with reference to the above description, but instead should be determined with reference to the appended claims along with their full scope of equivalents. For example, one or more embodiments of the present invention are applicable for use in fabricating a reflection type LCD device, a transflective (i.e., transmission/reflection) type LCD device, a plasma panel device, and so forth.

1. A method for fabricating a display that comprises:
fabricating a sealing wall having a first height about a periphery of first display structures that have been fabricated on a first substrate;
fabricating a containment wall having a second height about the periphery and outside the sealing wall, the second height being less than the first height;
dispensing a sealing material between the sealing wall and the containment wall;
contacting a second substrate having second display structures to the first substrate; and
setting the sealing material to bond the first and second substrates.

2. The method of claim 1 wherein the step of fabricating a containment wall comprises:
depositing an imprinting material on a substrate;
moving an imprint template towards the first substrate so that the imprinting material coats predetermined portions of a surface of the imprint template and a surface of the first substrate; and
energizing the imprinting material to cause a solid material in the form of a containment wall to be produced therefrom.

3. The method of claim 2 wherein depositing includes depositing a plurality of droplets upon the first substrate.

4. The method of claim 1 wherein the step of fabricating a sealing wall further includes fabricating separation posts having the first height at predetermined locations on a surface of the first substrate.

5. The method of claim 1 wherein the step of fabricating a sealing wall comprises depositing one or more of SiOₓ, SiNₓ, SiOₓN_{y}, and combinations thereof.

6. The method of claim 1 wherein the step of fabricating a sealing wall and separation posts comprises depositing one or more of SiOₓ, SiNₓ, SiOₓN_{y}, and combinations thereof.

7. The method of claim 1 wherein the step of fabricating a sealing wall and a containment wall comprises depositing one or more of SiOₓ, SiNₓ, SiOₓN_{y}, and combinations thereof.

8. The method of claim 2 wherein the step of fabricating a sealing wall comprises depositing one or more of SiOₓ, SiNₓ, SiOₓN_{y}, and combinations thereof.

9. A display that comprises:
a first substrate including first display structures;
a second substrate including second display structures; and
the first and second substrates being separated by a distance determined by a separation height of separators disposed at predetermined positions within the display;
wherein the first and second substrates are joined by a sealing material disposed between a sealing wall and a containment wall;
wherein the sealing wall has the separation height and is disposed about a periphery of the first and second display structures; and
wherein the containment wall has a height that is less than the separation height and is disposed the periphery and outside the sealing wall.

10. A method for fabricating a display that comprises:
fabricating a sealing wall having a first height about a periphery of first display structures that have been fabricated on a first substrate, a containment wall having a second height about the periphery and outside the sealing wall, the second height being less than the first height, separation posts having the first height at predetermined locations on a surface of the first substrate, and alignment features on the first substrate;
dispensing a sealing material between the sealing wall and the containment wall;
contacting a second substrate having second display structures to the first substrate; and
setting the sealing material to bond the first and second substrates.

11. The method of claim 10 wherein the step of fabricating the containment wall, the sealing wall, the separation posts, and the alignment features comprises:
depositing an imprinting material on a substrate;
moving an imprint template towards the first substrate so that the imprinting material coats predetermined portions of a surface of the imprint template and a surface of the first substrate; and
energizing the imprinting material to cause a solid material in the form of the containment wall, the sealing wall, the separation posts, and the alignment features to be produced therefrom.

12. The method of claim 11 wherein depositing includes depositing a plurality of droplets upon the first substrate.

13. The method of claim 11 wherein the imprinting material is polyimide.
